(19) United States
(12) Patent Application Publication
(10) Pub. No.: US 2026/0295950 A1
(43) Pub. Date: Oct. 1, 2026

(54) METHOD OF MAKING HOLLOW COMPONENT OF COMPOSITE MATERIAL USING COLLAPSABLE AND REUSABLE MANDREL

(71) Applicant: UNIVERSITÀ DEGLI STUDI DI CATANIA, Catania (IT)

(72) Inventors: Gianluca CICALA, Catania (IT); Claudio TOSTO, Catania (IT)

(73) Assignee: UNIVERSITÀ DEGLI STUDI DI CATANIA, Catania (IT)

(21) Appl. No.: 18/880,299

(22) PCT Filed: Mar. 27, 2023
(86) PCT No.: PCT/IB2023/053028

§ 371 Date: Dec. 31, 2024

(51) Int. Cl. B29C 70/44; B29C 33/50; B29C 33/76; B29K 105/00; B29K 105/08; B29K 105/24; B29K 701/10; B29L 23/00

(52) U.S. Cl. CPC B29C 70/446; B29C 33/505; B29C 33/76; B29K 2105/0002; B29K 2105/0017; B29K 2105/08; B29K 2105/24; B29K 2701/10; B29K 2833/08; B29K 2995/0082; B29L 2023/00

(57) ABSTRACT

A method of making a hollow product by curing a polymer matrix composite material and reinforcing fibers includes the steps of: —providing a hollow mandrel of a thermosetting polymeric material having a glass transition temperature greater than or equal to 50° C., preferably between 50° and 110° C., so as to be rigid at room temperature with an original shape, the mandrel further having a connector for pressurizing/depressurizing the mandrel through a fluid; —male mold laminating one or more layers of the composite material on the rigid mandrel; —heating the mandrel with the laminated layer to a curing temperature of the composite matrix, the curing temperature being higher than said glass transition temperature; —pressurizing the mandrel so as to maintain said original shape during the heating step; and—depressurizing the mandrel at a temperature higher than said glass transition temperature.

### CROSS REFERENCE TO THE RELATED APPLICATIONS

This application is the national phase entry of International Application No. PCT/IB2023/053028, filed on Mar. 27, 2023, the entire contents of which are incorporated herein by reference.

### TECHNICAL FIELD

The present invention relates to a method of making a hollow component by means of a collapsible and reusable mandrel, the hollow component being of a polymeric matrix composite material which can be male mold laminated on the mandrel, e.g. with elongated reinforcing fibers such as a pre-preg.

The invention therefore is included in the technical field of the production of mandrels or also known to those skilled in the art as preformed cores for making hollow bodies. More specifically, the invention can be included in the technical field of the production of mandrels by 3D printing or with additive manufacturing methods.

### BACKGROUND

Nowadays when hollow products must be made by molding, such as for example in the production of pipes in composite material fibers, it is usual to make use of mandrels or cores which occupy the hollow part of the piece to facilitate molding.

When instead the bodies are hollow and have particularly complex shapes, as for example in the case of bodies with variable section or other undercuts, the use, and the consequent extraction, of mandrels or manufacturing aids is prevented, for example, by the limited accessibility internal to the piece or by the structural characteristics of the core or mandrel e.g. stiffness that hinders or prevents extraction.

To overcome such drawbacks, three different approaches are currently known, which are useful above all for tackling the problem of extracting the mandrels from bodies having a complex geometry.

When the component to be made has hollow bodies in composite material that can be male mold laminated, these are usually made by stratification of dry layers, e.g. fabrics, in long or short fibers or pre-impregnated with resin. With reference to the invention, the fibers are preferably long and of a high resistance material such as carbon, aramid, glass, natural fibers of a vegetable nature, basalt-based fibers.

The first approach is to use semi-molds. These half-molds are hollow and the composite material is applied to form corresponding half-shells which are subsequently joined to compose the final product.

In these circumstances, the composite layer (or often the multilayer) is initially applied to the two half-molds which are then joined together. An expandable bag is inserted into the cavity formed by the joined half-molds, to then be pressurized during the curing of the resin and thus apply pressure to the layer against the half-molds.

This solution allows to obtain a high volumetric fraction of fiber, but at the same time it cannot be used for any geometry and rarely allows to obtain substantially constant thicknesses of the finished product, particularly in the presence of edges or cusps of the finished product. Indeed, the bag is fully collapsible and packable when deflated and the corresponding shape, when pressurized, tends to have large fillet radii so as to be unsuitable e.g. to obtain hollow bodies with polygonal cross section with few sides. Furthermore, it does not allow the so-called ‘male’ lamination, i.e. through the deposition of material on the mandrel, since the bag does not have its own structure rigid enough to support the composite layers and the application pressure, e.g. by the latter's hand.

Pieces made with this approach effectively include two halves joined together to form a single piece. The joint line, often contained in a plane, requires a finishing post-processing after the extraction from the mold, and above all, it defines an area wherein the probability of fracture of the piece is high.

The second approach provides for the use of so-called ‘break away’ mandrels, i.e. rigid mandrels at the time of application of the composite layer/s which are destroyed in order to be extracted from the hollow body.

These mandrels substantially replicate the geometry of the component to be made, and having sufficient stiffness, they allow male mold lamination as they resist undeformed to the applied pressure, e.g. manually during lamination. However, the removal of the mandrel and mandrel material residues after curing the polymer matrix of the laminated product requires mostly manual removal. The destruction of the mandrel carries with it the risk of damaging the component made of composite material, and in some cases it can be difficult or impossible to achieve, due to the difficulty of accessing the component internally. Furthermore, using a rigid core requires molds with carefully sizing tolerances in order to precisely define the residual volume for compacting the composite material, so that the mold can operate sufficient and necessary pressure on the composite to compact it. In such solutions it is also necessary that the mandrel maintains its shape at the curing temperatures.

Such a solution also has the drawback linked to the fact that the mandrel cannot be reused.

A third approach has therefore been developed which makes use of soluble cores. Soluble cores, such as break away cores, replicate the geometry of the component to be manufactured and allow male mold lamination. These cores also have the advantage that they can be removed by dissolving rather than by mechanical action.

Materials used in these cases are plasters and waxes, or soluble polymers. However, the use of these materials does not solve the problems of thermal inertia and control of the thermal expansion of the mandrel. Furthermore, the use of harsh chemicals for removal e.g. melting of the core can lead to the deterioration of the mechanical properties of the product made and of the composite fibers which it is made with. Furthermore, the use of waxes and plasters makes the creation of complex geometries laborious and difficult, in addition to the long time required for cleaning the piece.

It is therefore a scope of the present invention to provide a method for making a reusable mandrel and a related mandrel which are both practical to use and simple and economical to make.

A further scope of the present invention is to provide a method for making hollow components that are practical to use and simple and cheap to make.

A further scope of the present invention is to provide a mixture for making a collapsible and reusable mandrel capable of solving the drawbacks of the prior art, highlighted above.

A further scope of the present invention is to provide a collapsible and reusable mandrel which is at the same time rigid at room temperature, for example to allow male mold lamination of long and/or short dry woven and/or non-woven fibers, for example, of a carbon fiber, or a pre-preg of woven and/or non-woven fibers, and collapsible or flexible to be able to resist over-pressures at the curing temperatures and under-pressures with respect to the ambient pressure, to allow, for example, the compaction of the fibers and removal of the mandrel at the end of the process, respectively.

### SUMMARY

All of these scopes and others which will result from the following description are achieved by means of a method of making a composite material with a polymeric matrix and reinforcing fiber including the steps of:
providing a hollow mandrel of a thermosetting polymeric material having a glass transition temperature greater than or equal to 50° C., preferably between 50° and 110° C. so as to be rigid at room temperature i.e. 20° C. with an original shape, the mandrel further having a connector for pressurizing/depressurizing the mandrel through a fluid;
male mold laminating on the rigid mandrel one or more layers of composite material e.g. dry fibers and/or prepreg;
heating the mandrel with the laminated layer to a matrix curing temperature, e.g. the curing temperature is preferably between 80° and 160° or even 180° C. on the basis of the polymeric matrix and in any case higher than the glass transition temperature;
pressurizing the mandrel so as to maintain said original shape during the heating step;
depressurizing the mandrel at a temperature higher than said glass transition temperature so that, being the mandrel more flexible than the ambient temperature, the depressurization causes a collapse or contraction of the transversal dimension of the mandrel to thus favor the extraction of the mandrel from a product obtained by curing the matrix and reusing it having a three-dimensional shape after depressurization equal to the three-dimensional shape to which the male mold lamination is applied.

Depressurization at temperatures above the glass transition temperature i.e. ‘hot’ of the mandrel, allows to obtain a dimensional contraction of the mandrel to simplify the extraction even in the presence of undercuts in the laminated product of cured composite material. It is also important, during the curing of the polymeric matrix of the laminated product, to pressurize the mandrel which is at a temperature higher than the glass transition temperature. In fact, in the absence of this pressurization, the mandrel would tend to deform during curing, in turn deforming the laminated product during curing. This action is particularly effective in the presence of a counter-mold, as will be better discussed below.

At the same time, it is possible to male mold laminating the composite material on the mandrel when the latter is rigid e.g. male mold laminating on the mandrel at room temperature. The cured products of composite material thus have similar thicknesses, even in the vicinity of edges and cusps, similar to those of other areas, e.g. flat faces. It is thus possible to avoid localized accumulations of polymeric matrix in the cured product of composite material.

Furthermore, the mandrel is reusable since, being the mandrel of a thermosetting material, it regains its original shape after depressurization above the glass transition temperature. Furthermore, the curing of the mandrel is not significantly affected by the heat treatment for the matrix curing of the laminated product so as to avoid excessive stiffness of the mandrel even above the glass transition temperature.

All these scopes and others which will appear from the following description are also achieved, according to the invention, with a method of making a reusable mandrel, and a corresponding mandrel having the characteristics indicated in the attached claims.

All these scopes and others which will appear from the following description are also achieved, according to the invention, with a method of making hollow components having the characteristics indicated in the attached claims.

### BRIEF DESCRIPTION OF THE DRAWINGS

The technical features of the invention, according to the above scopes, are clearly described in the attached claims and its advantages are evident from the detailed description that follows, with reference to the attached drawings which illustrate embodiments thereof which are purely exemplary and non-limiting, wherein:

FIGS. 1A-1H schematically illustrate the steps of a method of making hollow components according to the present invention;

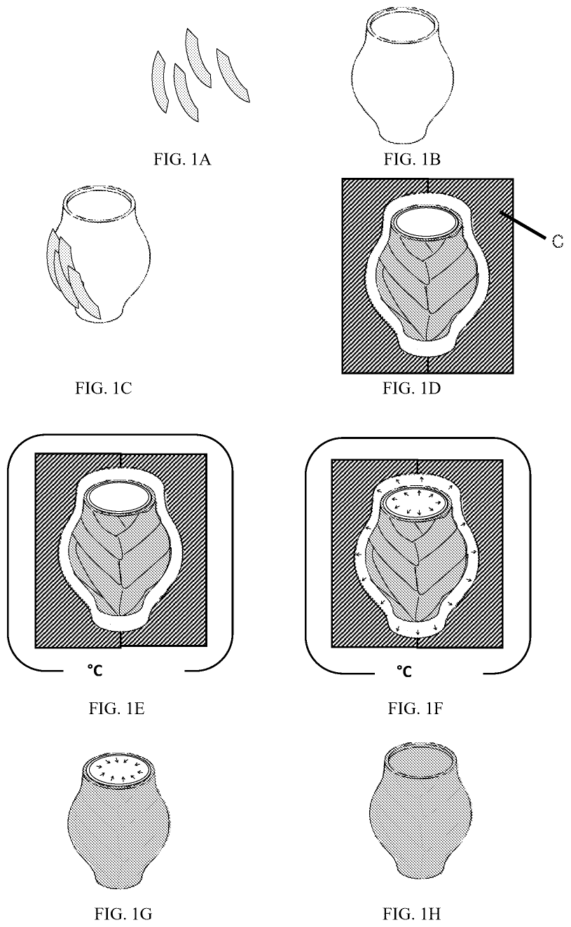

FIGS. 2-3 illustrate respectively the temperature and pressure cycle used in the method of FIGS. 1A-1H;

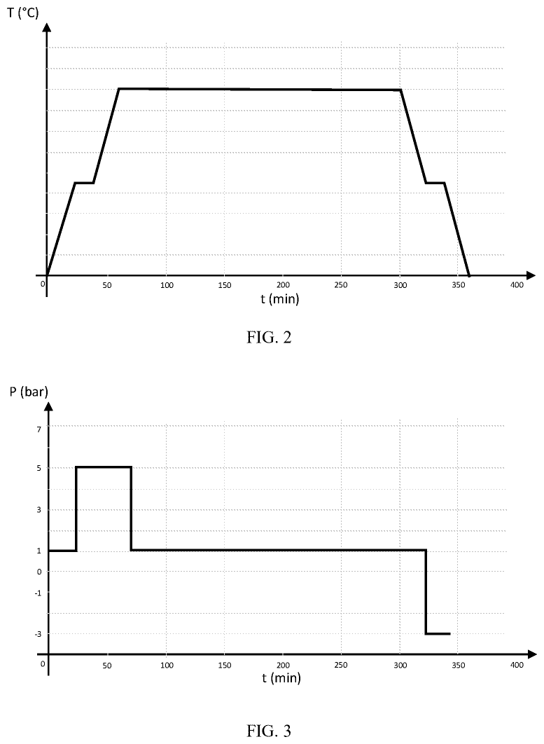

FIG. 4 illustrates following steps of hot depressurization of a hollow mandrel used according to the invention; and

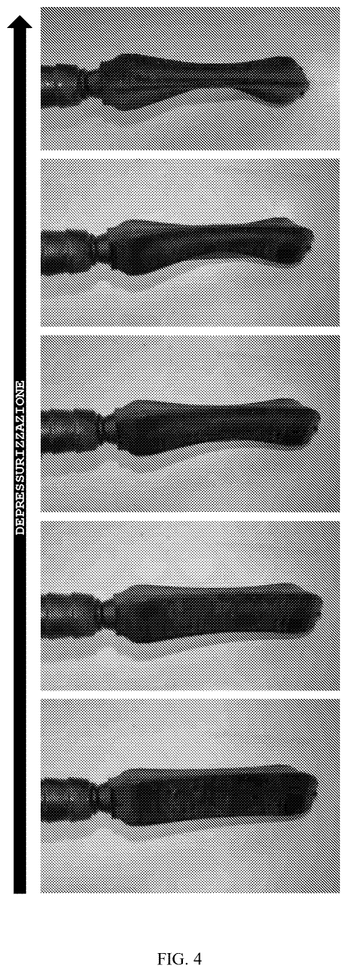

FIGS. 5-7 are corresponding views and sections of the hollow mandrel of FIG. 4.

### DETAILED DESCRIPTION OF THE EMBODIMENTS

The method of the present invention, described in greater detail in the paragraphs following Table 1, is performed by means of a collapsible and reusable mandrel M, made through a mixture of polymeric materials.

Meaning as reusable mandrel M a mandrel M which is neither destroyed nor dissolved, at the end of the hollow body manufacturing process, so that it can be reused for several machining cycles, and in any case for more than one machining cycle.

In the following, where reference is made to resin, it is to be understood as synonymous of mixture for the scopes of the present invention.

The thermosetting mixture for making a collapsible and reusable hollow mandrel M is based on polymeric materials to form a hollow mandrel M having rigid walls at room temperature to enable mandrel male mold lamination of a polymeric matrix composite material and short or elongated reinforcing fibers.

The thermosetting mixture for making the mandrel M is characterized by a glass transition temperature greater than or equal to 50° C., preferably between 50° C. and 110° C., and selected to be lower than the curing temperature of the matrix of the composite material of the product laminated so that it is possible to depressurize the mandrel M when hot, the walls of which, being in such conditions more flexible than the ambient temperature, collapse or contract to reduce the transversal dimension of the mandrel M and favor the extraction of the cured composite material from the piece. Preferably, the depressurization temperature is higher than the glass transition temperature of the mandrel M, preferably equal to the glass transition temperature increased by 10° C.

In particular, according to the present invention the thermosetting mixture for making the mandrel M includes an oligomer and one or more reactive diluents.

Furthermore, the mixture of the polymeric material of the mandrel M is made in such a way that its own curing, which has already occurred during the manufacturing step of the mandrel M, is not impacted or is only marginally impacted during the curing of the matrix of the composite material, so as to allow re-use of mandrel M for subsequent male mold laminations e.g. to obtain new units of the cured product of composite material.

More specifically, the polymeric mixture for making the mandrel M includes:
from 30% to 50% by weight of an acrylate, as an oligomer, the acrylate oligomer is selected from polypentamethylene glycol polyglycidyl ether, polyethylene glycol polyglycidyl ether blend epoxy methacrylate, polypropylene glycol polyglycidyl ether, polyether polyester urethane methacrylate, polytetramethylene glycol polyglycidyl ether, polytrimethylpropane polyglycidyl ether, polyglycerol polyglycidyl ether with composite hydroxy methacrylates such as hydroxymethyl methacrylate or hydroxyethyl methacrylate, and mixtures thereof;
from 50% to 70% by weight of one or more reactive diluents, the reactive diluent is selected from triethylene dimethacrylate, trimethylpropane trimethacrylate, monofunctional aliphatic urethane acrylate, and relative mixtures;
from 2% to 5% by weight, with respect to the 100% sum of oligomer and diluent, of a co-initiator, selected from composites of onium, iodonium, sulfonium, phosphonium, thiol and mercaptan such as 2-mercaptobenzothiazole, mercapto-benzimidazole, 2-mercaptoethanol, Pentaerythritol tetrakis(3-mercaptopropionate), and mixtures thereof;
from 1% to 3% by weight, with respect to the sum of 100% of oligomer and diluent, of a photo-initiator selected from bis-trimethylbenzoyl phenylphosphine oxide, Titanocene bis(trifluoromethanesulfonate), titanocene dichloride, (4S,5S)-Chloro-cyclopentadienyl-[2,2-dimethyl-1,3-dioxolane-4,5-bis(diphenylmethoxy)]titanium and mixtures thereof.

Such mixtures are cured with a photolithographic process to obtain a hollow mandrel M whose walls are rigid at room temperature i.e. the glass transition temperature of the mixture which forms the mandrel M is at least 50° C.

Furthermore, such a combination is particularly suitable for manufacturing the mandrel M by means of both stereolithographic and extrusion 3D printing, as better described below.

Advantageously, the acrylate includes one or more urethane reactive groups. In this way it is possible to give flexibility to the mandrel M.

Even more advantageously, the acrylate with a reactive group including urethane has a molecular weight between 60 g/mol and 150 g/mol.

Within this molecular weight range it is possible to obtain products with viscosities compatible with the 3D printing process and with the flexibility characteristics required by the expansion process object of the patent.

In some preferred embodiments the acrylate is di(trimethylolpropane)tetraacrylate.

Di(trimethylolpropane)tetraacrylate has the advantage of allowing fast reaction times compatible with the photopolymerization process in 3D printing (i.e. 20-40 s)

The reactive diluents, used in the mixture, participating in the reaction with the oligomer, favor the curing of the mixture during the production of the mandrel M by 3D printing. Their choice allows to obtain a hardness between 60-90 ShoreA and a stiffness lower than or equal to 1.5 GPa at the temperature at which the depressurization of the mandrel M is carried out, e.g. Tg+10°−20° C., but at the same time the necessary stiffness (i.e. greater than 1.5 GPa) of the mixture at room temperature to allow male mold lamination.

Advantageously, the reactive diluents are acrylates and/or epoxides. The choice between the use of an acrylate and/or an epoxide being linked to the degree of reactivity of the resin. In detail the reactive diluents are used when it is necessary to reduce the reactivity of the system while the acrylate group is chosen when it is necessary to increase the reactivity of the system.

The use of such reactive diluents allows to control the viscosity of the formulation before its photo-curing and, after the photo-curing, to control the value of the glass transition temperature of the formulation.

The value of the glass transition temperature of the photocured resin in 3D printing, Tg, must be compatible with the curing temperatures e.g. 120-180° C. of the matrix of the composite material of the laminated product, during the production of the product itself. In fact, this parameter controls the deformability of the 3D printed mandrel M and, therefore, allows, as better indicated below, to exert an internal pressure on the layer during curing by applying an internal pressure to the core and thus deforming the walls. Preferably, the glass transition temperature of the photocured mixture for the mandrel M is selected on the basis of the curing temperature of the matrix so that the latter does not exceed by maximum of 30° C. the glass transition temperature of the matrix. Given the most commonly used matrices in composite materials with elongated reinforcing fibers, the glass transition temperature is at least 50° C.

Advantageously, the use of acrylates and/or epoxides as reactive diluents makes it possible to ensure that the curing of the mixture occurs only during the manufacturing process of the mandrel M, i.e. during the 3D printing of the mandrel M, and not also in the oven or in the autoclave.

That is, e.g. in the case of stereolithography, such diluents allow photo-curing of the mandrel M material e.g. during 3D printing, but not thermal curing, the flexibility of the walls of the M mandrel being achieved by exceeding the glass transition temperature.

In this way the properties of the mandrel M are kept intact during the production of a hollow body, for example in a composite material, both at room temperature and during the curing of the composite material

In other words, when the mandrel M is subjected to the temperatures typical of the curing processes of polymeric matrix composite materials e.g. pre-impregnated, whether in the oven or in the autoclave, the curing of the resin of the mandrel M is prevented or does not progress significantly.

In this way the mandrel M does not modify its thermo-mechanical properties in the various production cycles of hollow bodies. For example, the mandrel M does not harden in a stable manner after passing through an oven or autoclave, thus allowing it to be reused for several processing cycles.

Advantageously, the reactive diluents belong to the group including: difunctional aliphatic urethane acrylate, triethyleneglicoldimethacrylate, or tricyclodecane dimethanol diacrylate, or a combination thereof is used.

The use of difunctional aliphatic urethane acrylate, triethyleneglicoldimethacrylate, tricyclodecane dimethanol diacrylate, or a combination thereof, has the advantage of providing a reactivity of the mixture in times ranging from 20-40 s.

In further embodiments, the mixture also includes a co-initiator for regulating the reactivity of the mixture, i.e. for making the curing of the mixture more or less rapid. In this way the rate of the polymerization reaction of the mixture is regulated.

Advantageously, the mixture includes 4-acetamidothiophenol as co-initiator, from 1% to 5% by weight with respect to the total.

4-acetamidothiophenol has the advantage of favoring photo-curing in the visible range. The photo-initiator activates the curing by absorbing light where the mixture is to be cured in LCd machines. For photo-curing with DLP machines, with LED-type light sources, it is sufficient to provide traditional photocatalysts.

By polymerization source is meant the light, produced by suitable means for activating the curing of the photo-initiator. The light can be in variable spectra between 300 and 460 nm according to the type of photoinitiators used.

The polymerization source is, for example, the light produced by a laser in SLA 3D printing (stereolithography), digital light projector in DLP (i.e. digital light processing) 3D printing, or one or more light sources in the case of printing 3D LCDs.

The polymerization light source can vary from 300 to 460 nm according to the type of technology used (i.e. SLA, DLP or LCD).

Advantageously, the mixture includes 2-hydroxy-2-methyl-1-phenyl-propan-1-one as photo-initiator from 1% to 5% by weight.

2-hydroxy-2-methyl-1-phenyl-propan-1-one has the advantage of activating the photo-curing of methacrylate.

In a preferred embodiment, the mixture has the composition shown in Table 1.

TABLE 1

| Funzione | Polimero | % |
|---|---|---|
| Oligomer | Di(trimethylolpropane)tetraacrylate | 45.6 |
| Reactive diluent | difunctional aliphatic urethane acrylate | 24.3 |
| Reactive diluent | triethyleneglicoldimethacrylate | 16.5 |
| Reactive diluent | Tricyclodecane dimethanol diacrylate | 8.2 |
| Co-iniziator | 4-acetamidothiophenol | 2.8 |
| Photo- initiator | 2-hydroxy-2-methyl-1- | 2.6 |
| | phenyl-propan-1-one | |

The Tg of the mixture of Table 1 is 70° C. and can be used with matrixes of the pre-impregnated composite with curing temperatures in the oven and/or autoclave higher than 70° C.

A hollow mandrel M produced with the above material has mechanical characteristics that vary with the temperature, e.g. at room temperature it has a modulus of elasticity greater than 1.5 GPa and a tensile strength greater than 40 MPa. At the curing temperatures of the layer e.g. of a prepreg i.e. 70-180° C. the material is more yielding e.g. the modulus of elasticity is less than or equal to 1.5 GPa and the elongation is greater than or equal to 30%.

According to a further aspect of the present invention, the thermo-mechanical properties of the hollow mandrel M produced with the mixture described above, for example with the composition shown in Table 1, are exploited to obtain a core which can be used for the production of hollow components in composite material with polymer matrix, e.g. in carbon fiber. In particular, for the production of a hollow component of composite material using the mandrel M described above, a method based on male mold lamination on the hollow core is used. In particular, this method includes the step of preparing a layer of reinforcing fibers, such as for example carbon fiber, and resin or matrix, wherein said resin includes an epoxy polymer and can also be extended to other types of thermosetting matrices such as for example, unsaturated polyester, ester cyanates, benzoxazines as long as with curing temperatures consistent with the Tg of the resin used for the mandrel M. Furthermore, such method provides for the step of preparing a hollow mandrel M having its own three-dimensional shape provided by the process of forming of the same using the mixture described above, e.g. a parallelepiped, a cube, a sphere, etc. or other complex shape. A counter-mold configured to house the hollow mandrel M and the at least one layer during the curing of the latter is also preferably provided. In this way, this method provides for the step of applying, preferably at room temperature or lower but without the aid of cooling chambers or the like, the reinforcing layer and the resin on the mandrel M to perform the male mold lamination. To favor the adhesion of the reinforcing layer on the mandrel M, this operation is performed by applying a mechanical load on the reinforcing layer so as to make the latter adhere by compaction on the surface of the mandrel M e.g. to minimize the presence of air pockets interposed between the reinforcing layer and the surface of the mandrel M. According to one aspect of the present invention, thanks to the thermo-mechanical properties of the material with which the mandrel M is made, at room temperature or in any case during male lamination, the latter maintains its three-dimensional shape defined as at the end of the forming process even under the application of a mechanical load of compaction of the reinforcing layer on a wall of the mandrel M. In particular, the walls of the mandrel M are rigid enough that during lamination, e.g. at room temperature, the pressure applied to the core is mainly supported by bending of the walls of the mandrel M, which, under the action of the load, do not deform or may present a minimal elastic deformation towards the cavity and, at the end of the lamination, such as to cause the mandrel M to maintain its three-dimensional shape unchanged with respect to that at the beginning of the lamination process. In this way, it can be understood that the walls of the mandrel M can deform towards the cavity as a user pushes on the reinforcing layer but, thanks to the thermo-mechanical properties of the material of the mandrel M, when the lamination is finished, the three-dimensional shape of the mandrel M is substantially equal to that of the mandrel M before applying the reinforcing layer thereon. Furthermore, any minimum deformation of the mandrel M caused by the application of pressure e.g. manual on the layer is recovered in an elastic way at the end of the male mold lamination. Sometimes, during lamination, a pressurization of the mandrel cavity M may be provided, e.g. by inserting a pressurized diathermic fluid such as air, water, etc., in such a way as to generate a counter-pressure on the walls of the mandrel M in the opposite direction to the pressure acting on the reinforcing layer during curing. Such a pressurization contribution is lower than the elastic flexural contribution of the walls in order to contrast the pressure applied on the reinforcing layer. Therefore, once the male mold lamination on the mandrel M has been completed, the method preferably includes the step of positioning the mandrel M with the layer in the counter-mold. According to a further aspect of the present invention, the counter-mold is configured to have a three-dimensional shape such as to reproduce the three-dimensional shape of the core, such that the walls of the counter-mold C with respect to the walls of the mandrel M are spaced apart by a predefined offset and such as to generate a gap between the core and the counter-mold C. In particular, this gap has a thickness, which will subsequently be the thickness of the product in composite material. Therefore, by means of the composition discussed above, it is possible to make a mandrel M which at room temperature is rigid for the scopes of male mold lamination and has its own three-dimensional shape which, preferably, is a smaller than 1 scale reproduction of the three-dimensional cavity defined by the counter-mold C.

In particular, being rigid for lamination purposes even when not pressurized, the hollow mandrel M can have shapes such as edges and/or flat faces and/or cusps and/or curvature discontinuities which are impossible to obtain using a pressurized bag. Furthermore, by means of the rigid hollow mandrel M according to the present invention it allows male mold lamination even in the absence of pressurization unlike a preformed bag or bladder whose walls are shaped but, being flexible at room temperature since they are made e.g. in rubber whose Tg is lower than 0° C., they would deform during application e.g. of a pre-preg during a male lamination in the absence of internal pressurization.

If instead the layer e.g. the pre-preg, after lamination on the hollow mandrel M, is inserted into a hollow counter-mold C, and the hollow mandrel M has a scaled-down three-dimensional shape of the cavity shape of the counter-mold C, the thickness of the composite material product is considerably more homogeneous and/or it is possible to make edges or cusps with smaller radius than those achievable using a bladder.

Therefore, according to both embodiments with vacuum bag or counter-mold C, the lamination of the layer is followed by thermal curing of the polymeric matrix of the layer, this curing having no impact on the curing of the hollow mandrel M. Preferably, for this purpose, curing of the hollow mandrel M takes place by exposure to a light, e.g. laser or ultraviolet light or at a curing temperature.

Furthermore, according to the present invention, during the thermal curing of the matrix of the composite material layer, the hollow mandrel M is pressurized and, thanks to the achievement during the curing of the laminated product of a range of temperatures 10-20° C. higher than the temperature of glass transition of the mandrel M, the action of this pressurization, being the walls of the hollow mandrel M more yielding or elastically deformable, is transmitted to the layer so as to compact it against the counter-mold C.

Once curing of the matrix has taken place but still at a temperature of the hollow mandrel M in the above mentioned range or in any case at a temperature higher than or equal to Tg, the hollow mandrel Mis depressurized to obtain a collapse and/or contraction or the like and is thus extracted from the product. It is therefore possible, through this collapse or contraction, to also make a product of composite material with one or more undercuts.

Furthermore, when the hollow mandrel M returns to room temperature, thanks to the relatively high glass transition temperature of the mixture, the initial three-dimensional geometry is re-established, i.e. prior to lamination to start a new production cycle.

According to a preferred embodiment, the hollow mandrel M of the present invention is shaped by means of a 3D printing process, in particular a 3D tank printing with photopolymer and light source. Preferably, each cured layer during printing of the hollow core is between 3 and 5 millimeters. Furthermore, 3D printing for photopolymer is preferably LCD (masked stereolithography) because in this way surface roughness and surface finishes are obtainable such that, once transferred to the layer during curing, they do not require further processing of the cured product and the latter is separated from the collapsed or contracted core in a substantially ready-to-use condition, at least as regards finishing operations referring to the lateral surfaces of the composite material product.

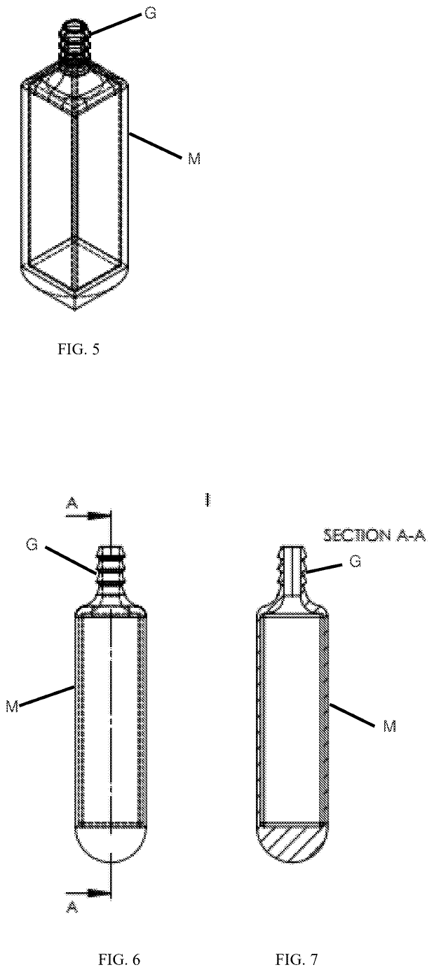

FIGS. 5-7 illustrate a non-limiting embodiment of the single-body hollow mandrel M having a shape e.g. parallelepiped. An internal volume of the mandrel M is fluidically connected to a pressure source via a connector G of the mandrel itself, for example via a fluid-tight connection e.g. spiked or similar. Preferably, the connector G is a narrower section with respect to the remaining portion of the mandrel M, as illustrated in FIGS. 5-7: in use, the mandrel M remains empty, e.g. without the possibility of housing stiffening components inside since the latter are incompatible with the dimensions of the G connector. Through the G connector, the mandrel is pressurized/depressurized. In particular, to restore the original shape after a production cycle, e.g. after depressurization for extraction from the hollow product of composite material, the mandrel M is heated again above its Tg, preferably but not exclusively at the same temperature as the previous depressurization and/or pressurization in the presence of the hollow product of composite material. This heating is performed in the absence of the hollow product of composite material and, after the consequent cooling, the mandrel M is ready for a new lamination.

What is claimed is:

1. A method of making a hollow product by curing a polymer matrix composite material and reinforcing fibers, comprising the following steps:
providing a hollow mandrel of a thermosetting polymeric material having a glass transition temperature greater than or equal to 50° C., to be rigid at a room temperature with an original form, wherein the hollow mandrel further has a connector for pressurizing/depressurizing the hollow mandrel through a fluid;
male mold laminating one or more layers of the polymer matrix composite material on the hollow mandrel;
heating the hollow mandrel with a laminated layer to a curing temperature of the polymer matrix composite material, the curing temperature being higher than the glass transition temperature;
pressurizing the hollow mandrel to maintain the original form during the heating; and
depressurizing the hollow mandrel at a temperature higher than the glass transition temperature, wherein the hollow mandrel is more flexible than an ambient temperature, a depressurization causes a collapse or a contraction of a transversal dimension of the hollow mandrel to thus favor an extraction of the hollow mandrel from a product obtained with the curing of the polymer matrix composite material and a reuse of the hollow mandrel, and the hollow mandrel after the depressurization has a three-dimensional shape substantially equal to the original form.

2. The method according to claim 1, further comprising: surrounding with a counter-mold C the hollow mandrel, wherein one or more layers is applied on the hollow mandrel; and pressurizing with the counter-mold C to apply a load on the one or more layers against the counter-mold C.

3. The method according to claim 1, wherein the pressurizing and/or the depressurizing is applied via a diathermic fluid at an inlet/outlet of the hollow mandrel, wherein the diathermic fluid is: air, water, one or more silicone oils, or a combination thereof.

4. The method according to claim 16, wherein the hollow mandrel has the three-dimensional shape on a scale smaller than 1 of a three-dimensional shape of the counter-mold C, and the three-dimensional shape of the hollow mandrel and the three-dimensional shape of the counter-mold C present at least one undercut.

5. The method according to claim 1, wherein the thermosetting polymeric material of the hollow mandrel comprises:
30% to 50% by weight of acrylate,
one or more reactive diluents, overall from 50% to 70% by weight,
optionally 2% to 5% by weight, based on a 100% sum of an oligomer and the reactive diluents, of a co-initiator, and
optionally 1% to 3% by weight, based on the 100% sum of the oligomer and the reactive diluents, of a photo-initiator.

6. The method according to claim 5, wherein the acrylate comprises a reactive group comprising urethane, to provide flexibility to the hollow mandrel.

7. The method according to claim 6, wherein the acrylate is di(trimethylolpropane)tetraacrylate.

8. The method according to claim 7, wherein the one or more reactive diluents are acrylates and/or epoxides.

9. The method according to claim 8, wherein the one or more reactive diluents belong to a group comprising: difunctional aliphatic urethane acrylate, triethyleneglycoldimethacrylate, tricyclodecane dimethanol diacrylate, or a combination thereof.

10. The method according to claim 5, wherein the thermosetting polymeric material further comprises the co-initiator from 1% to 5% by weight, wherein the co-initiator is 4-acetamidothiophenol.

11. The method according to claim 5, wherein the thermosetting polymeric material further comprises the photo-initiator from 1% to 5% by weight, wherein the photo-initiator is 2-hydroxy-2-methyl-1-phenyl-propan-1-one.

12. The method according to claim 1, further comprising: forming the hollow mandrel for superimposed layers by 3D printing.

13. The method according to claim 12, wherein the forming comprises curing the thermosetting polymeric material by a curing light source.

14. The method according to claim 1, further comprising: pressurizing the hollow mandrel after heating the hollow mandrel to a further temperature higher than the glass transition temperature, thus restoring the original form to proceed with a further lamination.

15. The method according to claim 1, wherein the depressurization is carried out at a temperature of the hollow mandrel higher than the glass transition temperature of the hollow mandrel.

16. The method according to claim 2, wherein the pressurizing and/or the depressurizing is applied via a diathermic fluid at an inlet/outlet of the hollow mandrel, wherein the diathermic fluid is: air, water, one or more silicone oils, or a combination thereof.

17. The method according to claim 2, wherein the depressurization is carried out at a temperature of the hollow mandrel higher than the glass transition temperature of the hollow mandrel.

18. The method according to claim 3, wherein the depressurization is carried out at a temperature of the hollow mandrel higher than the glass transition temperature of the hollow mandrel.

19. The method according to claim 17, wherein the hollow mandrel has the three-dimensional shape on a scale smaller than 1 of a three-dimensional shape of the counter-mold C, and the three-dimensional shape of the hollow mandrel and the three-dimensional shape of the counter-mold C present at least one undercut.

20. The method according to claim 2, wherein the thermosetting polymeric material of the hollow mandrel comprises:
30% to 50% by weight of acrylate, and
one or more reactive diluents, overall from 50% to 70% by weight,
optionally 2% to 5% by weight, based on a 100% sum of an oligomer and the reactive diluents, of a co-initiator, and
optionally 1% to 3% by weight, based on the 100% sum of the oligomer and the reactive diluents, of a photo-initiator.
